(19) United States
(12) Patent Application Publication
(10) Pub. No.: US 2016/0028648 A1
(43) Pub. Date: Jan. 28, 2016

(54) Resource Management Service

(71) Applicant: AT&T Intellectual Property I, L.P., Atlanta, GA (US)

(72) Inventors: Randolph Wohlert, Austin, TX (US); Paul Gausman, Bridgewater, NJ (US)

(73) Assignee: AT&T Intellectual Property I, L.P., Atlanta, GA (US)

(21) Appl. No.: 14/340,993

(22) Filed: Jul. 25, 2014

(51) Int. Cl. H04L 12/911; H04L 29/08

(52) U.S. Cl. CPC H04L 47/783; H04L 67/18; H04L 67/1095

(57) ABSTRACT

Concepts and technologies are disclosed herein for a resource management service. A content usage report can be received at a processor executing a resource management service. The processor can generate a model that indicates content used by a computing device and geographic locations at which the content is used. The processor can determine anticipated content that is expected to be received by the computing device and an anticipated location at which the anticipated content is expected to be received. The processor can identify a resource available to support storage of the anticipated content and generate a command to allocate the resource to support storage of the anticipated content. The processor can instruct the resource to download the anticipated content and to store the anticipated content.

### BACKGROUND

Bandwidth limitations present challenges for network operators. Because of the proliferation of Internet-enabled devices and increasingly common usage of data and voice networks to communicate, these challenges are becoming more pronounced recently. During certain peak hours, networks may be flooded with requests and/or communications that may consume a great deal of network resources.

Such demand on network resources can result in several problems. First, high demand can stress network devices, which can result in reduced bandwidth available to handle communications. Second, high network utilization can result in increased latency and/or other performance degradation. As response time increases, the issues of latency and other types of degradation may increase, for example, due to users reissuing commands when those commands are not responded to in a typical timeframe.

Because users tend to move through communications networks while simultaneously maintaining network connectivity, these challenges can impact all parts of a network. For example, whereas data delivery issues were confined primary to a DSL network, or the like, only ten years ago, modern networks must accommodate data requests and communications at almost any time and at almost any location. As a result, the challenges faced by network operators to maintain quality of service for an ever-increasing number of subscribers continue to increase and pose challenges for future growth of these networks.

### SUMMARY

The present disclosure is directed to a resource management service. The resource management service can be a callable service hosted and/or executed by one or more computing resources such as a server computer. The resource management service can obtain one or more content usage reports (“reports”). The reports can include data that defines content usage by a user, device, or other entity at or near a particular geographic location. The resource management service can analyze the report to identify various types and/or instances of information. In particular, the resource management service can identify, based on the report, one or more of a particular user, account, device, or other entity; content consumed, used, or otherwise interacted with by the entity; a geographic location at which the content interaction occurred; and a time at which the content interaction occurred.

The resource management service can generate a model based upon the information identified in the report. The model can represent content usage associated with the entity. The model also can represent movements and/or location associated with the entity, as well as times at which the entity interacts with content. The model also can include trends and/or history data that can represent location trends and/or usage trends associated with the entity. The model can be stored in a data store device such as a data store.

At some time, the resource management service can determine that an anticipated demand associated with the entity should be identified. Based upon this determination, which can be based on requests, queries, schedules, trigger events, or the like, the resource management service can analyze the models. The resource management service also can obtain network data from one or more network reporting devices or mechanisms. Based upon the analysis of the model, the resource management service can anticipate demand associated with the entity. The anticipated demand can be determined not only in terms of content that is anticipated to be consumed or used by the entity, but also a time and location at which this anticipated demand is expected to occur.

Based upon the analysis of the network data, the resource management service can determine one or more resources that can accommodate the anticipated content usage (also referred to herein as demand). The resource management service can determine if the identified resources are available. If the resources are not available, the resource management service can schedule a time at which the resources will be allocated. If the resources are available, the resource management service can allocate the resources to accommodate the anticipated demand. According to various embodiments, the resources can include data storage resources. As part of the allocation, the resource management service can issue a command to create a virtual private locker for the entity and issue commands to the resources to download the content associated with the anticipated demand and to store the content in the virtual private locker. Thus, when the entity requests the content, the content can be located at a geographically proximate location, thereby reducing load on the network, in some embodiments.

According to one aspect of the concepts and technologies disclosed herein, a method is disclosed. The method can include receiving, at a processor executing a resource management service, a content usage report including geographic location data and content usage data. The processor can generate, based upon the content usage report, a model that indicates content used by a computing device and geographic locations at which the content is used. The method also can include determining, by the processor and based upon the model, anticipated content that is expected to be received by the computing device and an anticipated location at which the anticipated content is expected to be received. The processor can identify a resource available to support storage of the anticipated content and generate generating a command to allocate the resource to support storage of the anticipated content. The processor also can instruct the resource to download the anticipated content and to store the anticipated content.

In some embodiments, the anticipated content is downloaded to a virtual private locker associated with the computing device. The virtual private locker can be located within a predetermined proximity of the anticipated location. The virtual private locker can include a virtual data storage device, and the resource can include a virtual computer.

In some embodiments, identifying the resource can include obtaining network data that indicates availability of network resources including the resource, determining that the resource is available and that the resource is located within a proximity of the anticipated location, and selecting the resource. In some embodiments, identifying the resource can include obtaining network data that indicates availability of network resources including the resource, determining that the resource is unavailable and that the resource is located within a proximity of the anticipated location, scheduling a time at which the resource is to be selected, and selecting the resource at the time scheduled.

In some embodiments, the report can include profile data identifying an entity associated with the content usage and time data identifying a time at which the content was used. The model can include profile data, time data, the content usage data, the location data, and history data. The history data can identify a trend associated with data included in the model. In some embodiments, the content usage data can include a uniform resource identifier via which the content is accessed. In some embodiments, instructing the resource to download the anticipated content can include determining that the anticipated content is pre-loadable, instructing the resource to create a virtual private locker, and instructing the resource to download the anticipated content and to store the anticipated content in the virtual private locker.

According to another aspect of the concepts and technologies disclosed herein, a system is disclosed. The system can include a processor and a memory. The memory can store computer-executable instructions that, when executed by the processor, cause the processor to perform operations including receiving a content usage report including geographic location data and content usage data, generating, based upon the content usage report, a model that indicates content used by a computing device and geographic locations at which the content is used, and determining, based upon the model, anticipated content that is expected to be received by the computing device and an anticipated location at which the anticipated content is expected to be received. The operations further can include identifying a resource available to support storage of the anticipated content, generating a command to allocate the resource to support storage of the anticipated content, and instructing the resource to download the anticipated content and to store the anticipated content.

In some embodiments, the anticipated content can be downloaded to a virtual private locker. In some embodiments, the virtual private locker can be associated with the computing device. The virtual private locker can be located within a predetermined proximity of the anticipated location. In some embodiments, identifying the resource can include obtaining network data that indicates availability of network resources including the resource, determining that the resource is available and that the resource is located within a proximity of the anticipated location, and selecting the resource. In some embodiments, instructing the resource to download the anticipated content can include determining that the anticipated content is pre-loadable, instructing the resource to create a virtual private locker, and instructing the resource to download the anticipated content and to store the anticipated content in the virtual private locker.

According to yet another aspect, a computer storage medium is disclosed. The computer storage medium can have computer-executable instructions stored thereon. When the computer-executable instructions are executed by a processor, the processor can perform operations. The operations can include receiving a content usage report including geographic location data and content usage data, generating, based upon the content usage report, a model that indicates content used by a computing device and geographic locations at which the content is used, and determining, based upon the model, anticipated content that is expected to be received by the computing device and an anticipated location at which the anticipated content is expected to be received. The operations also can include identifying a resource available to support storage of the anticipated content, generating a command to allocate the resource to support storage of the anticipated content, and instructing the resource to download the anticipated content and to store the anticipated content.

In some embodiments, the anticipated content can be downloaded to a virtual private locker. In some embodiments, the virtual private locker can be associated with the computing device. The virtual private locker can be located within a predetermined proximity of the anticipated location. In some embodiments, identifying the resource can include obtaining network data that indicates availability of network resources including the resource, determining that the resource is available and that the resource is located within a proximity of the anticipated location, and selecting the resource. In some embodiments, instructing the resource to download the anticipated content can include determining that the anticipated content is pre-loadable, instructing the resource to create a virtual private locker, and instructing the resource to download the anticipated content and to store the anticipated content in the virtual private locker.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a system diagram of an illustrative operating environment for the various embodiments disclosed herein.

FIG. 2 is a flow diagram showing aspects of a method for generating resource usage models, according to an illustrative embodiment.

FIG. 3A is a flow diagram showing aspects of a method for predicting or anticipating resource needs and instantiating resources based upon resource usage models, according to an illustrative embodiment.

FIG. 3B is a flow diagram showing aspects of a method for managing resources created based upon resource usage models, according to an illustrative embodiment.

FIG. 4A schematically illustrates a data structure for representing a resource usage model or a content usage report, according to an illustrative embodiment.

FIG. 4B schematically illustrates a data structure for representing network data, according to an illustrative embodiment.

FIG. 5 schematically illustrates a network, according to an illustrative embodiment.

FIG. 6 is a block diagram illustrating an example computer system configured to provide a resource management service, according to some illustrative embodiments.

FIG. 7 is a block diagram illustrating an example mobile device configured to interact with a resource management service, according to some illustrative embodiments.

### DETAILED DESCRIPTION

The following detailed description is directed to a resource management service. The resource management service can be hosted and/or executed by one or more computing resources such as a server computer. The resource management service can obtain one or more content usage reports (“reports”) from resources in communication with the resource management service. The reports can include data that defines content usage by a user, device, or other entity at or near a particular geographic location. The resource management service can analyze the report to identify various types of information. In particular, the resource management service can identify, based on the report, a particular user, account, device, or other entity. The resource management service also can identify content consumed, used, or otherwise interacted with by the entity. The resource management service also can determine a geographic location at which the content interaction occurred. The resource management service also can determine a time at which the content interaction occurred.

The resource management service can generate a content usage model (“model”) based upon the information included in the report and can store the report in a data storage device. The model can represent content usage associated with the entity. The model also can represent movements and/or location information associated with the entity, as well as times at which the entity interacts with content. The model also can include trends and/or history data that can represent location trends, time trends, and/or usage trends associated with the entity.

The resource management service can determine that an anticipated demand associated with the entity is to be identified in response to a request, a query, a schedule, a trigger event, or the like. The resource management service 110 can analyze one or more of the models. Based upon the analysis of the model, the resource management service can anticipate demand associated with the entity. The anticipated demand can be determined not only in terms of content that is anticipated to be consumed or used by the entity, but also a time and location at which this anticipated demand is expected to occur.

The resource management service also can obtain network data from one or more network reporting devices or mechanisms. Based upon the analysis of the network data, the resource management service can determine one or more resources that can be allocated to accommodate the anticipated demand. If the resources are available, the resource management service can allocate the resources to accommodate the anticipated demand. According to various embodiments, the resources can include data storage resources. As part of the allocation, the resource management service can issue a command to create a virtual private locker for the entity and issue commands to the resources to download the content associated with the anticipated demand and to store the content in the virtual private locker. Thus, when the entity requests the content, the content can be located at a geographically proximate location, thereby reducing load on the network, in some embodiments.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

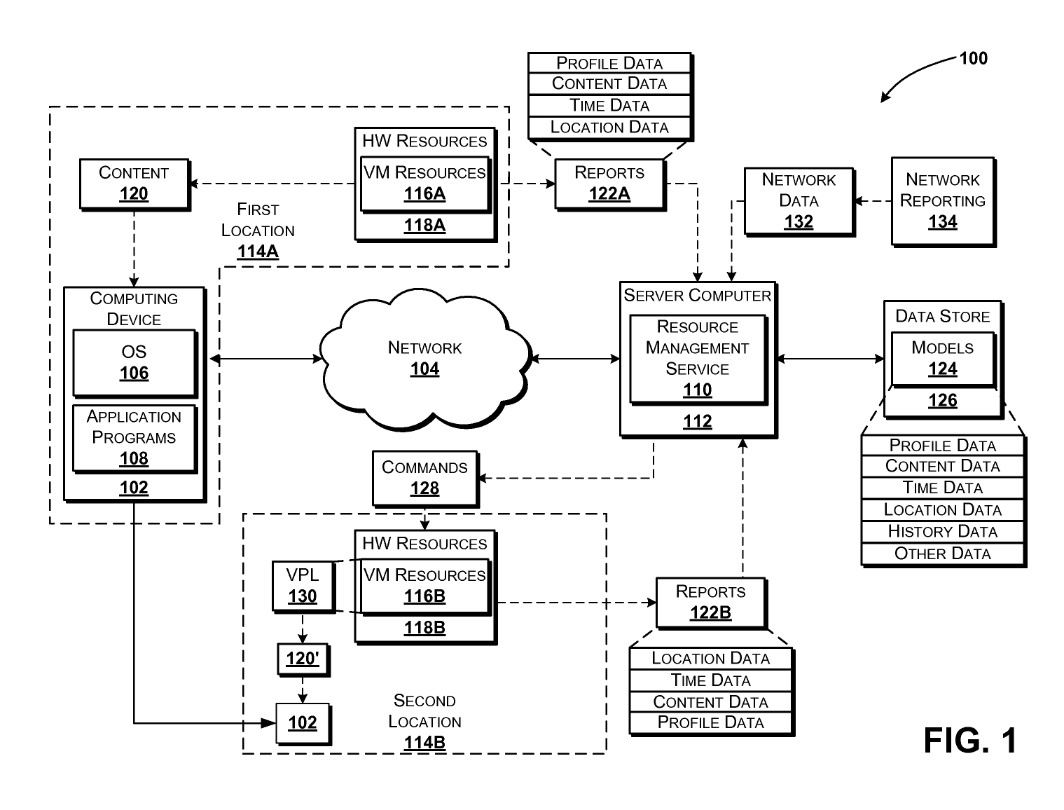

Referring now to FIG. 1, aspects of an operating environment 100 for various embodiments of the concepts and technologies disclosed herein for a resource management service will be described, according to an illustrative embodiment. The operating environment 100 shown in FIG. 1 includes a computing device 102 operating in communication with and/or as part of a communications network (“network”) 104.

According to various embodiments, the functionality of the computing device 102 may be provided by one or more server computers, desktop computers, mobile telephones, smartphones, portable media devices, laptop computers, set-top boxes, embedded computing systems, vehicle computing systems, other computing systems, and the like. It should be understood that the functionality of the computing device 102 can be provided by a single device, by two similar devices, and/or by two or more dissimilar devices. For purposes of describing the concepts and technologies disclosed herein, the computing device 102 is described herein as a smartphone. It should be understood that this embodiment is illustrative, and should not be construed as being limiting in any way.

The computing device 102 can execute an operating system 106 and one or more application programs 108. The operating system 106 can include a computer program for controlling the operation of the computing device 102. The application programs 108 can include executable programs configured to execute on top of the operating system 106 to provide various functions for the computing device 102. According to various embodiments of the concepts and technologies described herein, the application programs 108 can include web browsers, video applications, camera applications, email applications, shopping applications, combinations thereof, or the like. Because the various types of application programs supported by vehicle computing systems, smartphones, desktop computers, server computers, or other embodiments of the computing device 102 are generally understood, the application programs 108 are not further described herein, and the above examples should be understood as being illustrative and should not be construed as being limiting in any way.

According to some embodiments of the concepts and technologies described herein, the computing device 102 can communicate with a resource management service 110. According to some other embodiments, the resource management service 110 can operate without communicating with the computing device 102. According to various embodiments, the resource management service 110 can be hosted and/or executed by a computing resource such as a server computer 112. It should be understood that this example is illustrative and therefore should not be construed as being limiting in any way.

The resource management service 110 can be configured to perform various operations as illustrated and described in more detail below for providing a resource management service. In particular, the resource management service 110 can obtain information that indicates how, when, and where the computing device 102 uses or interacts with data. The resource management service 110 also can create data models that represent how, when, and where the computing device 102 uses or interacts with data. Based on these data models, the resource management service 110 can determine computing and data storage needs and/or anticipated content demand and/or usage associated with the computing device 102, and issue various instructions to various entities to accommodate the determined needs and/or demand. As will be explained in more detail below, the computing and data storage needs can be provided by various hardware and software resources. Some embodiments of processes for determining the computing and data storage needs of the computing device 102, as well as some embodiments of processes for accommodating the determined computing and data storage needs are illustrated and described below.

In the illustrated embodiment shown in FIG. 1, the computing device 102 is shown as initially being located at a first location 114A. The first location 114A can be defined in a number of ways or manners. For example, the first location 114A can correspond to an area served by a particular receiver, transmitter, or transceiver of a wireless network. Thus, for example, the first location 114A can be defined as an area served by and/or in communication with a WiFi hotspot; a base transceiver station or equivalent such as a radio base station, a node B, a base station, eNode B, or the like; a base station controller or equivalent; an antenna or antenna array; combinations thereof; or the like.

In some embodiments, the computing device 102 can be determined to be located at the first location 114A (or other location) based upon the computing device 102 being within a predetermined proximity of the first location 114A. For example, if the computing device 102 can connect to a wireless device located within the first location 114A, the computing device 102 may be determined to be located at the first location 114A. Thus, the predetermined proximity can be defined as a distance up to and within which the computing device 102 can still connect to a device located at the first location 114A. The predetermined proximity also can be defined in terms of distance such as one hundred feet or less, fifty feet or less, ten feet or less, or the like. It should be understood that these examples are illustrative and therefore should not be construed as being limiting in any way.

The first location 114A also can be defined as a particular geographic location. As such, the first location 114A can be defined by or as a specific geographic location within specific boundaries, a region, a city block, an area associated with a ZIP code, a city, a town, a state, or the like. The first location 114A also can be defined as a particular facility such as, for example, an outdoor area, a park, a sports arena, a building, a room, an office, a store, or the like. Because the first location 114A can be defined in additional and/or alternative ways, it should be understood that these examples are illustrative and therefore should not be construed as being limiting in any way.

According to various embodiments, the first location 114A can be defined by corresponding geographic boundaries, by defining hardware at or near the first location 114A, combinations thereof, or the like. Thus, for example, the first location 114A can be defined by the computing device 102 being in communication with one or more hardware devices (e.g., a WiFi transceiver, a BLUETOOTH beacon, a BTS, or the like). Additionally, or alternatively, the first location 114A can be defined as geographic boundaries or coordinates and the computing device 102 can be determined to be at that location based upon its global positioning system (“GPS”) coordinates, or the like. For purposes of illustrating and describing the concepts and technologies described herein, the first location 114A is described herein as a geographic location defined by GPS coordinates. In light of the various possible embodiments listed above, it should be understood that this example is illustrative and therefore should not be construed as being limiting in any way.

When located at or in proximity to the first location 114A, the computing device 102 can communicate with various resources associated with the network 104 and/or other networks. In the illustrated embodiment, the computing device 102 communicates with virtual machine resources (labeled “VM resources” in FIG. 1) 116A. The virtual machine resources 116A can include, for example, virtual computing resources and/or virtual data storage resources. According to various embodiments of the concepts and technologies described herein, the virtual machine resources 116A can include a virtual server computer and a virtual data store such as a virtual private locker (not shown with respect to the virtual machine resources 116A). As will be illustrated and described in more detail below, the virtual private locker can store data associated with the computing device 102.

According to various embodiments, the virtual machine resources 116A can be hosted, executed, or otherwise provided by hardware resources (labeled “HW resources” in FIG. 1) 118A. The hardware resources 118A can include, for example, one or more computing devices such as desktop computers, laptop computers, mobile telephones, smartphones, server computers, server farms, combinations thereof, or the like. For purposes of illustrating and describing the various embodiments of the concepts and technologies described herein, the hardware resources 118A are described herein as one or more server computers. It should be understood that this example is illustrative and therefore should not be construed as being limiting in any way.

While FIG. 1 illustrates the hardware resources 118A and the virtual machine resources 116A being located within or at the first location 114A, it should be understood that this is not necessarily the case. In particular, it should be understood that the virtual machine resources 116A and the hardware resources 118A can be located remote from the first location 114A, and that hardware at the first location 114A such as an antenna, or the like, can be used to link the virtual machine resources 116A and the hardware resources 118A with the computing device 102. As such, the illustrated embodiment should be understood as being illustrative of one contemplated embodiment and should not be construed as being limiting in any way.

The computing device 102 can communicate with the virtual machine resources 116A to obtain content 120. The content 120 can include almost any type of data that can be received by, consumed by, transmitted by, and/or otherwise interacted with by the computing device 102. According to various embodiments, for example, the content 120 can include, but is not limited to, video data such as streaming video and/or video files; audio data such as streaming audio and/or audio files; telephone data such as phone calls and/or IP phone data, control messages, text messages, multimedia messages, or the like; web data such as websites, images, text, scripts, or the like; web applications and/or web application data; and/or any other data that may be streamed to, pushed to, downloaded by, transmitted by, and/or otherwise interacted with by the computing device 102 during electronic communications via hardware located at the first location 114A. It should be understood that these examples are illustrative and therefore should not be construed as being limiting in any way.

According to various embodiments, the virtual machine resources 116A and/or the hardware resources 118A can be configured to generate one or more content usage reports (“reports”) 122A. The reports 122A can capture information describing content usage, consumption, and/or interactions at or near the first location 114A; content usage, consumption, and/or interactions via the virtual machine resources 116A; content usage, consumption, and/or interactions via the hardware resources 118A; content usage, consumption, and/or interactions by the computing device 102; combinations thereof; or the like. Thus, the reports 122A can include data that described how, when, and where data was communicated, transmitted, received, used, consumed, and/or otherwise interacted with by the computing device 102. It should be understood that the reports 122A can be generated at various times and for multiple devices, users, accounts, or other entities. For purposes of simplifying the description of the concepts and technologies described herein, however, only one computing device 102 is shown in FIG. 1.

According to various embodiments, the reports 122A can include, but are not limited to, profile data, content usage data (“content data”), time data, and geographic location data (“location data”). The profile data can identify a user, device, or profile associated with usage of, communication of, and/or consumption of the content 120. In some embodiments, the profile data can identify a device that received, transmitted, consumed, used, or was otherwise involved with the content 120. For example, in the illustrated embodiment, the profile data can identify the computing device 102. It should be understood that this example is illustrative and therefore should not be construed as being limiting in any way.

The content data can identify the content 120 received by, transmitted by, consumed by, and/or otherwise interacted with by the computing device 102. Thus, the content data may identify a filename, a uniform resource link (“URL”), or another content identifier; a content type; a data size or data rate associated with the content 120; a source or an author associated with the content 120; combinations thereof; or the like. Thus, the content data can describe the content 120 and/or can be used to determine or define data usage and/or data usage rates associated with the content 120. Because content can be identified and/or described in additional and/or alternative ways, it should be understood that the above examples are illustrative and should not be construed as being limiting in any way.

The time data can identify a time the content 120 was requested, received, transmitted, consumed, used, and/or otherwise interacted with by the computing device 102 at the first location 114A. The time data can be used to define time in various manners. For example, the time data can define a day of the year, a day of the month, a day of the week, a time of day, a time range, a specific date, or the like. The time data also can define time in relative terms. For example, the time data can indicate that the content 120 is interacted with ten, twenty, or thirty minutes after some other event. Of course, relative times can be defined in seconds, minutes, hours, days, weeks, or even years, and as such the above examples are illustrative and should not be construed as being limiting in any way.

The location data can identify a location at which the content 120 was interacted with. The location data can reflect various levels of particularity with regard to location, including but not limited to the various ways the first location 114A can be defined as indicated above. Thus, for example, the location data can define a geographic location such as a country, a province, a state, a county, a city, an area associated with a ZIP code, a city block, a building, and/or a specific location coordinates such as GPS coordinates. In light of the various examples provided above for defining the first location 114A, it should be understood that these examples of the location data are illustrative and therefore should not be construed as being limiting in any way.

The resource management service 110 can receive, download, or otherwise obtain the reports 122A from the hardware resources 118A. According to some embodiments of the concepts and technologies described herein, the resource management service 110 can request the reports 122A from the virtual machine resources 116A or the hardware resources 118A, and the resource management service 110 can receive the reports 122A in response to the request. According to some other embodiments, the resource management service 110 can receive the reports 122A from the virtual machine resources 116A or the hardware resources 118A without requesting the reports 122A.

According to yet other embodiments of the concepts and technologies described herein, the resource management service 110 can download the reports 122A from the virtual machine resources 116A or the hardware resources 118A. In still other embodiments, the resource management service 110 can receive the reports 122A from the virtual machine resources 116A or the hardware resources 118A based on scheduled transmissions, at times at which the reports 122A are generated, and/or on-demand. Because the reports 122A can be obtained by the resource management service 110 in additional and/or alternative manners, it should be understood that these examples are illustrative and therefore should not be construed as being limiting in any way.

The resource management service 110 can analyze the reports 122A. Based upon the analysis of the reports 122A, the resource management service 110 can identify content consumed by devices or users at particular times at particular locations. As noted above, the resource management service 110 can analyze the reports 122A to determine how, when, and where the computing device 102 consumes data.

The resource management service 110 can generate one or more resource and content usage models (“models”) 124 based upon the analyzed reports 122A. Thus, for example, the resource management service 110 can use the profile data, the content data, the time data, the location data, and/or other data included in the reports 122A to generate the models 124. In some embodiments, the resource management service 110 can identify a user or profile associated with a particular report 122A, identify a model 124 associated with the user or profile, and update or change the model 124 based upon data included in the report 122A. In some other embodiments, the resource management service 110 can create a new model 124 for the user or profile. It should be understood that this example is illustrative and therefore should not be construed as being limiting in any way.

The models 124 can be stored at a data storage device such as a data store 126. The functionality of the data store 126 can be provided by one or more databases, server computers, desktop computers, mobile telephones, laptop computers, other computing systems, and the like. In the illustrated embodiments, the functionality of the data store 126 can be provided by a database in communication with the server computer 112. It should be understood that this example is illustrative and therefore should not be construed as being limiting in any way.

The models 124 can include various data that describe content usage and/or usage habits of users. In the illustrated embodiment of FIG. 1, the models 124 can include profile data. The profile data can include information identifying users, accounts, or devices (e.g., a profile name, a phone number, an IMEI, a MAC address, combinations thereof, or the like). The models 124 also can include content data. As explained above, the content data can identify content received by, transmitted by, consumed by, and/or otherwise interacted with by the computing device 102.

The models 124 also can include time data. As explained above, the time data can identify one or more times at which data consumption occurred or occurs. The models 124 also can include history data. The models 124 also can include location data. As explained above, the location data can identify one or more locations at which data consumption occurred or occurs.

The models 124 also can include history data. The history data can indicate various trends or histories associated with the computing device 102. The history data can store trends or histories associated with any of the other data included in the models 124. Thus, for example, the history data can indicate trends or histories of locations, time, content usage, or the like. These aspects of the models 124 can be used by the resource management service 110 to determine and/or accommodate anticipated usage, as will be illustrated and described in more detail below. The models 124 also can include other data such as account details, account restrictions, device details, device statistics, combinations thereof, or the like.

In addition to creating the models 124, the resource management service 110 also can analyze the models 124 at various times to anticipate content usage and/or resource needs. According to various embodiments of the concepts and technologies described herein, the resource management service 110 can analyze one or more of the models 124 to determine resource and/or content needs based upon those models 124. According to various embodiments illustrated and described herein, the resource management service 110 can predict or anticipate content consumption, demand, or other usage associated with one or more users or devices, a location associated with the predicted or anticipated content usage, particular instances of content associated with the predicted or anticipated content usage, times associated with the predicted or anticipated content usage, combinations thereof, or the like.

Based upon the determined anticipated or predicted content usage, the resource management service 110 can create resources to support the anticipated or predicted content usage. For example, as shown in FIG. 1, the resource management service 110 can determine that a particular instance of content 120′ is likely to be consumed or otherwise used by a user or user device (e.g., the computing device 102) at a second location 114B. This determination can be based upon analysis of the models 124 to determine a historical content consumption associated with the computing device 102, as explained above.

Based upon the determination by the resource management service 110 that the content 120′ is likely to be consumed or used at the second location 114B, the resource management service 110 can identify one or more hardware resources 118B located at the second location 114B. The resource management service 110 can identify hardware resources 118B that can support the anticipated demand. It should be understood that this example is illustrative and therefore should not be construed as being limiting in any way.

The resource management service 110 can issue commands 128 to the hardware resources 118B. The commands 128 can request or direct the hardware resources 118B to create, instantiate, or otherwise make available virtual machine resources 116B to support the anticipated content. The virtual machine resources 116B can include computing resources and/or data storage resources. According to various embodiments of the concepts and technologies described herein, the virtual machine resources 116B can include a virtual private locker (labeled “VPL” in FIG. 1) 130. The virtual private locker 130 can be configured to store the content 120′ associated with the anticipated demand. According to various embodiments of the concepts and technologies described herein, the content 120′ can be preloaded to the virtual private locker 130. As such, the content 120′ can, in some embodiments, be located at the location 114B and ready for interaction with by the computing device 102 at the anticipated time with a request being made for the content 120′ by the computing device 102.

Thus, as shown in FIG. 1, when the computing device 102 enters the second location 114B and requests the content 120′, the content 120′ can be retrieved by the virtual machine resources 116B and/or the hardware resources 118B from the virtual private locker 130 and provided to the computing device 102 without requiring interactions with other devices or hardware. Thus, when the computing device 102 requests the content 120′, the content 120′ can be provided to the computing device 102 without accessing other devices or entities on the network 104. Thus, some embodiments of the concepts and technologies described herein can be used to reduce load across a network at specific times, if desired.

In some embodiments of the concepts and technologies described herein, content such as the content 120′ can be preloaded to virtual machine resources such as the virtual machine resources 116B at times of low network usage and/or traffic. For example, the content 120′ can be loaded to the virtual private locker 130 in the early morning hours, when network traffic is minimal.

According to various embodiments of the concepts and technologies described herein, the resource management service 110 can access network planning data, network operational data, network usage statistics, and/or other network load and/or availability data (“network data”) 132 from one or more network reporting mechanisms (labeled “network reporting” in FIG. 1) 134. Thus, the resource management service 110 can determine, based on the models 124 and the network data 132, times at which the content 120′ is to be obtained and/or loaded to the virtual private locker 130. Thus, some embodiments of the concepts and technologies described herein can be used to preload the content 120′ to the virtual private locker 130 while minimizing network usage and/or load at particular times. It should be understood that this example is illustrative and therefore should not be construed as being limiting in any way.

As shown in FIG. 1, the hardware resources 118B also can be configured to generate reports such as the reports 122B. These reports 122B can similarly be communicated to the resource management service 110. The resource management service 110 can use the reports 122B to refine or generate the models 124 as explained above with regard to the reports 122A. As such, the models 124 can be dynamic models that can be updated each time content is used and/or consumed. It should be understood that this example is illustrative and therefore should not be construed as being limiting in any way.

FIG. 1 illustrates one computing device 102, one network 104, one server computer 112, two locations (the first location 114A and the second location 114B), two sets of virtual machine resources (the virtual machine resources 116A and the virtual machine resources 116B), two sets of hardware resources (the hardware resources 118A and the hardware resources 118B), and one data store 126. It should be understood, however, that various implementations of the operating environment 100 can include zero, one, or more than one computing device 102; zero, one, or more than one network 104; zero, one, or more than one server computer 112; zero, one, two, or more than two sets of virtual machine resources; zero, one, two, or more than two sets of hardware resources; and/or zero, one, or more than one data store 126. As such, the illustrated embodiment should be understood as being illustrative, and should not be construed as being limiting in any way.

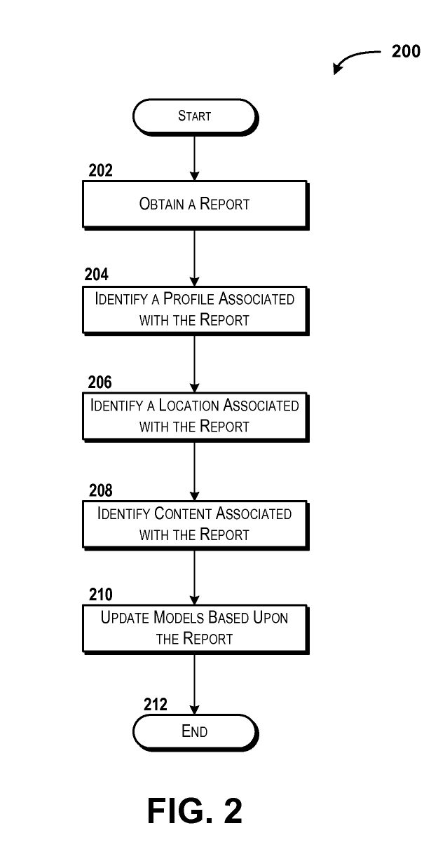

Turning now to FIG. 2, aspects of a method 200 for generating resource usage models will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as, the computing device 102 or the server computer 112 to perform one or more operations and/or causing the processor to direct other components of the computing system or device to perform one or more of the operations.

For purposes of illustrating and describing the concepts of the present disclosure, the methods disclosed herein are described as being performed by the server computer 112 via execution of one or more software modules such as, for example, the resource management service 110. It should be understood that additional and/or alternative devices and/or network nodes can provide the functionality described herein via execution of one or more modules, applications, and/or other software including, but not limited to, the resource management service 110. In particular, as will be explained in more detail below, the computing device 102 can be configured to execute various applications or modules to provide the functionality described herein with reference to FIG. 2. As such, the illustrated embodiments are illustrative, and should not be viewed as being limiting in any way.

The method 200 begins at operation 202. At operation 202, the server computer 112 obtains a report. The report obtained in operation 202 can relate to usage or other interaction with content. As illustrated and described above with reference to FIG. 1, the report obtained in operation 202 can be similar to the reports 122A, 122B. As such, the report obtained in operation 202 can include data that indicates or describes usage or other interactions with content such as the content 120. It should be understood that this example is illustrative and therefore should not be construed as being limiting in any way.

As explained above in detail with reference to FIG. 1, the report obtained in operation 202 can be obtained in a number of manners and can include various types of information and/or data. The report can be transmitted to the server computer 112 by one or more hardware resources such as the hardware resources 118A or hardware resources 118B, by virtual resources (via hardware) such as the virtual machine resources 116A or the virtual machine resources 116B, and/or by other entities. The report can be transmitted according to one or more schedules, transmitted when created or updated, transmitted in response to a request, and/or transmitted in response to other triggering events. As such, it should be understood that the resource management service 110 can receive the report obtained in operation 202 at almost any time.

Furthermore, as explained above with reference to FIG. 1, the report obtained in operation 202 can include data such as the profile data. The profile data can indicate a user, profile, or device associated with a particular instance of content usage. The report obtained in operation 202 also can include data such as the content data. The content data can indicate a particular instance of content interacted with by the user, profile, or device.

The report obtained in operation 202 also can include data such as the time data. The time data can indicate a time, in absolute or relative terms, that an instance of content was interacted with by the user, profile, or device. The report obtained in operation 202 also can include data such as the location data. The location data can indicate a particular location at which an instance of content was interacted with by the user, profile, or device. Because the report obtained in operation 202 can include additional and/or alternative information, it should be understood that these examples are illustrative and therefore should not be construed as being limiting in any way.

From operation 202, the method 200 proceeds to operation 204. At operation 204, the server computer 112 can identify a profile associated with the report obtained in operation 202. In some embodiments, as explained above, the report obtained in operation 202 can include profile data. As such, the server computer 112 can identify the profile based upon the profile data included in the report. In some other embodiments, the report can specify a user or device, and the server computer 112 can identify the profile by accessing or querying the models 124 to identify a profile that relates to the user or device.

The profile data and/or the data used by the server computer 112 to identify the profile can include, but are not limited to, a login and/or password, a user name, an account number, an account name, a telephone number, an IP address, an international mobile equipment identity (“IMEI”), an international mobile subscriber identity (“IMSI”), a media access control (“MAC”) address, a device serial number, combinations thereof, or the like. In light of the description of the reports 122A, 122B and the models 124 illustrated and described in FIG. 1, and based on the various ways in which devices and/or users can be identified, it should be understood that various methods of identifying a profile and/or user associated with the reports are possible and are contemplated. As such, the above examples are illustrative and should not be construed as being limiting in any way.

Regardless of how the profile associated with the report is identified, the server computer 112 can identify, in operation 204, a person, user, account, device, or other entity associated with the report. As such, operation 204 can include the server computer 112 identifying an entity associated with an instance of content usage or consumption represented by the report obtained in operation 202. Thus, activity described by the report can be associated with a particular entity such as a user, device, account, or the like. It should be understood that this example is illustrative and therefore should not be construed as being limiting in any way.

From operation 204, the method 200 proceeds to operation 206. At operation 206, the server computer 112 can identify a location associated with the report. As explained above with reference to FIG. 1, the reports 122A, 122B can include location data. As such, the report obtained in operation 202, which can be similar or even identical to the reports 122A, 122B can include location data. As such, in operation 206 the server computer 112 can parse or extract location data or other location information from the report obtained in operation 202. The server computer 112 also can analyze the report received in operation 202 to determine the location, or otherwise can determine a location associated with the report received in operation 202.

In some embodiments, for example, the server computer 112 can receive data indicating the location associated with the report as part of the report itself. In some other embodiments, the server computer 112 can obtain the report and can separately receive or obtain data indicating the location from other entities and/or devices such as, for example, a location server, hardware associated with the network 104 and/or other entities, combinations thereof, or the like. In some embodiments, the server computer 112 can obtain the report and can request data indicating the location associated with the report. In yet other embodiments, the data indicating the location can be provided to the server computer 112 without making any request. Because the location can be determined in a variety of manners, including but not limited to the examples provided above, it should be understood that these examples are illustrative and therefore should not be construed as being limiting in any way.

From operation 206, the method 200 proceeds to operation 208. At operation 208, the server computer 112 can identify content associated with the report. As explained above with reference to FIG. 1, the reports 122A, 122B can include content data that can identify content interacted with by a device or user such as the computing device 102. As such, the report obtained in operation 202, which can be similar or even identical to the reports 122A, 122B can include content data that identifies content used, consumed, and/or interacted with by the computing device 102. Thus, operation 208 can include, for example, the server computer 112 parsing or extracting the content data from the report received in operation 202, analyzing the report received in operation 202 to identify the content, or otherwise identifying content associated with the report received in operation 202.

As explained above with reference to FIG. 1, the content can be identified as a content type; as a particular source of data such as a stream, URL, or the like; as a particular file size and/or data rate; combinations thereof; or the like. Thus, it should be understood that the content data can identify a particular instance of content in some embodiments, while in some other embodiments, the content data can identify a type and/or rate of network resource usage. According to various embodiments of the concepts and technologies described herein, the content data identifies the content or a type of content so that this content can be preloaded and/or located to a virtual private locker 130 at a particular location. It should be understood that this example is illustrative and therefore should not be construed as being limiting in any way.

From operation 208, the method 200 proceeds to operation 210. At operation 210, the server computer 112 can update the models 124 based upon the report received in operation 202. As explained above with reference to FIG. 1, the models 124 can include multiple data usage models, and one or more of the multiple models can be associated one or more users, devices, and/or other entities. As such, in operation 210, the server computer 112 can access the models 124, and can update one or more of the models 124 based upon the report obtained in operation 202. According to various embodiments, the server computer 112 can update one of the models 124, where the one model 124 is identified based upon the profile identified in operation 204, the location identified in operation 206, and/or the content identified in operation 208.

According to various embodiments, the model 124 is identified based upon the profile, which as explained above can associate activity relating to content with a particular profile such as a device, a user, an account, or another entity. It should be understood that the models 124 can be updated to create a new model 124, in some instances, while in other instances the models 124 can be updated to modify or update one of the models 124. Thus, according to various embodiments of the concepts and technologies described herein, the method 200 can be executed by the server computer 112 to create or update a model 124 associated with a particular user, account, or device.

It can be appreciated that the models 124 illustrated and described herein can be generated in a number of manners, and are not necessarily created or generated only using the method 200 illustrated and described herein. According to some other embodiments, for example, the models 124 can be generated by network operators or other authorized entities and stored in the data store 126. According to some other embodiments, the computing device 102 or other devices or entities can be configured to execute a model generation application. In one contemplated embodiment, the model generation application is included as one of the application programs 108 executed by the computing device 102.

The model generation application can track usage of the computing device 102. Thus, the model generation application can generate reports such as the reports 122A, 122B shown in FIG. 1. The reports generated by the model generation application can indicate content interacted with by the computing device 102, one or more times at which the content was interacted with by the computing device 102, one or more locations at which the content was interacted with by the computing device 102, or the like. The computing device 102 can transmit the reports to the resource management service 110 as illustrated and described above in FIG. 1. It should be understood that this example is illustrative and therefore should not be construed as being limiting in any way.

According to some other embodiments, the model generation application can track the usage of the computing device 102, but instead of generating reports, the model generation application can generate one or more models 124. Thus, the model generation application can perform the functionality illustrated and described hereinabove with reference to the method 200 to generate models 124. The models 124 can be transmitted to the resource management service 110 and the resource management service 110 can store the models 124 in the data store 126 for use in predicting demand, if desired. It should be understood that this example is illustrative and therefore should not be construed as being limiting in any way.

From operation 210, the method 200 proceeds to operation 212. The method 200 ends at operation 212.

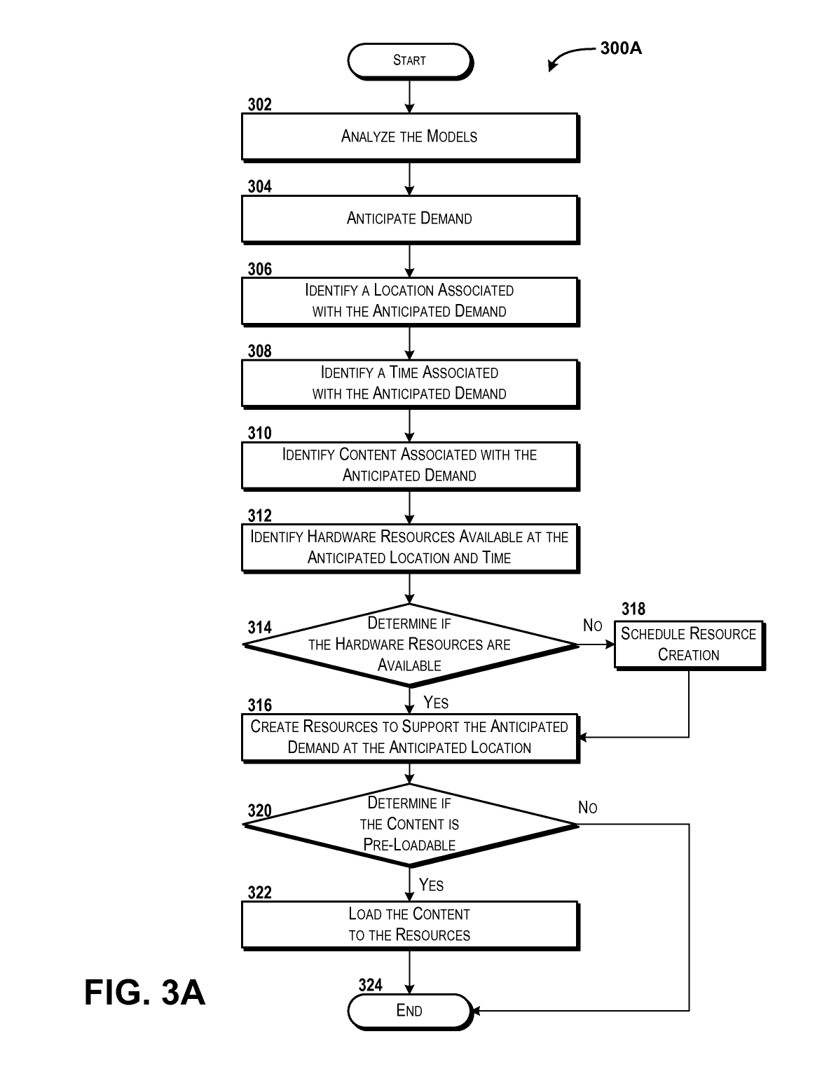

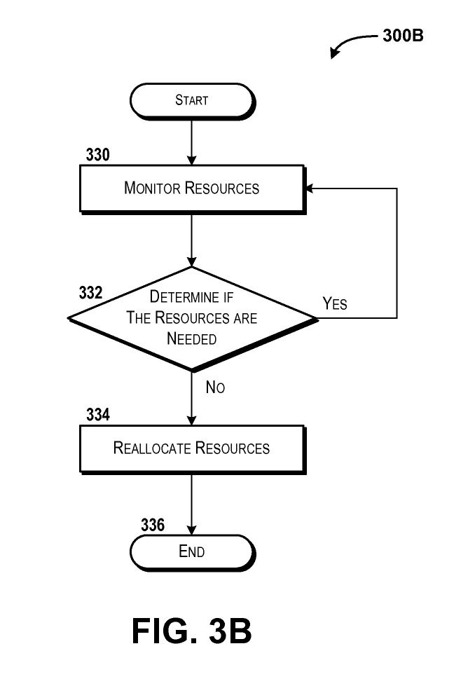

Turning now to FIG. 3A, aspects of a method 300A for predicting or anticipating resource needs and instantiating resources based upon resource usage models will be described in detail, according to an illustrative embodiment. As explained above with reference to the method 200 illustrated and described in FIG. 2, the method 300A is illustrated and described as being performed by the server computer 112. It should be understood that this example is illustrative and should not be construed as being limiting in any way.

The method 300A begins at operation 302. At operation 302, the server computer 112 can analyze the models 124. In some embodiments, the server computer 112 can analyze the models 124 in response to a request. For example, the server computer 112 can respond to a request to predict demand based upon the models 124. According to various embodiments of the concepts and technologies described herein, the request can be an explicit request generated by another entity such as a resource planning device, a network operations entity, or the like.

According to some other embodiments, the request to analyze the models 124 can be implicitly generated or may be omitted. For example, the resource management service 110 can be configured to access the models 124 to predict demand at various times such as, for example, once per month, once per week, once per day, once per hour, once per minute, or the like. In some embodiments, the server computer 112 can be configured to analyze the models 124 according to various schedules and/or in response to various trigger conditions. Because the analysis illustrated in operation 302 can be explicit or implicit, and because the analysis illustrated in operation 302 can be undertaken at various times and/or under various conditions, it should be understood that these examples are illustrative and therefore should not be construed as being limiting in any way.

From operation 302, the method 300A proceeds to operation 304. At operation 304, the server computer 112 can anticipate demand associated with the models 124. In operation 302, the server computer 112 can identify an expected consumption, usage, or other interaction with content. As explained above in FIGS. 1-2, the models 124 can include historical data in addition to other data describing particular interactions with content. As such, the models 124 can be analyzed to indicate trends and/or patterns associated with content consumption. Thus, for example, the server computer 112 can predict or anticipate that a particular user or device is expected to engage in a particular type of interaction with content based on the analysis of the models 124, as well as a time and location expected to be associated with this predicted or anticipated content interaction.

By way of example, a particular user, account, or device may be associated with a pattern or other history of interactions with content that can be captured by the models 124. The models 124 can indicate, for example, a pattern of movements of the user, device, or other entity. Still further, as noted above, the models 124 can indicate a pattern or history that indicates times and/or dates associated with content usage and/or interactions. Similarly, the models 124 can indicate specific data or types of data used by the user, device, or other entity and patterns or histories associated with these usages. Thus, by analyzing the models 124 in operation 304, the server computer 112 can identify one or more patterns regarding locations, time, and content usage associated with predicted or anticipated content interactions.

In one non-limiting example, the analysis of the models 124 by the server computer 112 may indicate, for example, that a user or device historically downloads email at a particular time of day at a particular location. Based on this determination, the server computer 112 can predict that the user or device will download email at a future time. The server computer 112 also can determine, based upon the analysis of the models 124, a location associated with the downloading of the email. It should be understood that this example is illustrative and therefore should not be construed as being limiting in any way.

In another non-limiting example, the analysis of the models 124 by the server computer 112 may indicate that a user or device historically accesses a stream of data when the user or device enters a location at a particular time or between two particular times. For example, the analysis of the models 124 by the server computer 112 may indicate that the user or device tends to access a stream of data when the user or device arrives home after a day at the office. Based on this determination, the server computer 112 can predict that the user or device will access the stream of data at a future time at their home location based upon knowledge of the movements and/or location trends associated with the user or device. It should be understood that this example is illustrative and therefore should not be construed as being limiting in any way.

In yet another example, the analysis of the models 124 by the server computer 112 may indicate that a user or device historically accesses a particular website or data source at a particular time of day or day of the week. It should be understood that these examples are illustrative and therefore should not be construed as being limiting in any way. Based on this determination, the server computer 112 can predict that the user or device will access the website or data source at a future time. It should be understood that this example is illustrative and therefore should not be construed as being limiting in any way.

From operation 304, the method 300A proceeds to operation 306. At operation 306, the server computer 112 can identify a location associated with the demand anticipated in operation 304. As can be appreciated with reference to FIG. 1 and the description of operation 304 above, the server computer 112 can identify one or more locations associated with anticipated demand. Thus, for example, the server computer 112 can determine, for a particular anticipated content usage or other interaction with content, a geographic location at which the anticipated content interaction is expected. For example, if the user or device tends to access a particular data source at a particular location (e.g., the home, office, on the road, etc.), the server computer 112 can identify that location in operation 306. It should be understood that multiple locations can be identified in operation 306. Because examples of determining locations are provided above with regard to the description of operation 304, additional examples will not be provided here.

From operation 306, the method 300A proceeds to operation 308. At operation 308, the server computer 112 can identify a time associated with the demand anticipated in operation 304. As can be appreciated with reference to FIG. 1 and the description of operation 304 above, the server computer 112 can identify one or more times or dates associated with anticipated demand. The times and/or dates can be defined in absolute terms, in some embodiments. For example, the time or date determined in operation 308 can include a specific absolute time and date such as, for example, Jul. 21, 2016 at 11:27 AM.

In some other embodiments, the time determined in operation 308 can be defined in as a time of day and/or day of the week, for example, which may be comparatively general when compared to the time and date example listed above. For example, the time or date determined in operation 308 can include a general definition of time and date such as, for example, Monday at 10:15 AM, every other day at 2:00 PM, each day at 3:30 PM, or the like.

In yet other embodiments, the time determined in operation 308 can be defined in relative terms. As such, the time determined in operation 308 can be based on other events and/or times. For example, time determined in operation 308 can be defined as every 30 minutes, every two hours, one and a half hours after a previous interaction, or the like. Because time can be defined in various manners, the examples above for determining time should be understood as being illustrative and should not be construed as being limiting in any way.

In one contemplated example of determining time, the server computer 112 can determine, for a particular anticipated content usage or interaction, a day of the year, a day of the month, a day of the week, a time of day, a specific time, an elapsed time, combinations thereof, or the like, at which the anticipated content interaction is expected. For example, if the user or device tends to access a particular data source at a particular time of day (e.g., 8:30 AM, every forty-five minutes, etc.), the server computer 112 can identify this time at operation 308. It should be understood that multiple times, days, and/or elapsed times can be identified in operation 308. Similarly, it should be understood that complex time definitions can be determined in operation 308 such as, for example, every two hours on Monday-Friday between the hours of 8:00 AM and 9:00 PM, and four hours after a previous interaction on Saturday and Sunday. It should be understood that this example is illustrative and therefore should not be construed as being limiting in any way.

From operation 308, the method 300A proceeds to operation 310. At operation 310, the server computer 112 can identify a particular instance of content or a type of content associated with the demand anticipated in operation 304. As can be appreciated with reference to FIG. 1 and the description of operation 304 above, the server computer 112 can identify one or more instances of content, one or more types of content, one or more amounts of data to be transferred, one or more data rates, combinations thereof, or the like, for the anticipated demand.

Thus, for example, the server computer 112 can determine, for a particular anticipated content usage or interaction, a filename, a file or data stream location, an amount of data associated with the anticipated data consumption or usage, a data rate associated with the anticipated data consumption or usage, combinations thereof, or the like. For example, if the user or device tends to access a particular data stream at a particular time or location (e.g., if the computing device 102 accesses a thirty second streaming weather report that totals 3.5 MB each morning at 6:30 AM from a home location), the server computer 112 can identify this data stream (the weather report), an anticipated amount of data associated with this data stream (3.5 MB), an anticipated data rate associated with this data stream (˜117 kB/s), combinations thereof, or the like. It should be understood that multiple data types, rates, amounts, or the like can be identified in operation 310.

From operation 310, the method 300A proceeds to operation 312. At operation 312, the server computer 112 can identify hardware resources that will be available at the anticipated location and time. The server computer 112 can base the determination in operation 312 on the location associated with the anticipated demand as determined in operation 306, the time associated with the anticipated demand as determined in operation 308, the content associated with the anticipated demand as determined in operation 310, and one or more instances of network data 132. As explained above, the network data 132 can capture current network operating characteristics and/or statistics, as well as network planning information that can indicate anticipated future network load associated with various network resources.

Thus, for example, the server computer 112 can identify not only hardware resources in the vicinity of the anticipated demand (e.g., at the location determined in operation 306), but also hardware resources that will be available at the anticipated time (e.g., the time determined in operation 308), and bandwidth and/or available resources to handle the content determined in operation 310. The server computer 112 also can determine, as part of the determination in 312, if the hardware resources identified in operation 312 are available to preload and/or store the content.

Thus, for example, the server computer 112 can analyze the content, location, and time and determine an amount of data and/or a data rate associated with the anticipated demand. The server computer 112 also can compare this information with various types of network data 132 to identify hardware resources at the location associated with the anticipated demand and/or at the anticipated time to determine what, if any, hardware resources are available to support the anticipated demand. As such, the server computer 112 can determine, in operation 312, how the anticipated demand is to be accommodated at the desired time. According to various embodiments, the server computer 112 can identify, in operation 312, hardware and/or virtual resources that can store the content for use or interaction at the anticipated time and/or location, as well as providing the content at the desired time and/or location.

According to various embodiments of the concepts and technologies described herein, the server computer 112 can identify hardware resources that can store the content in a user-specific virtual data storage location such as a virtual private locker 130. The virtual private locker 130 can be created at the location at which the content is anticipated to be interacted with. In some cases, the virtual private locker 130 can be created before the virtual private locker 130 is actually needed. Thus, virtual private locker 130 can be created and can be preloaded with the content that is anticipated to be needed or wanted.

In some instances, the server computer 112 can issue commands 128 to various network elements or the like to load or access the content associated with the anticipated demand and to locate that content at the virtual private locker 130 or other virtual machine resources at or near the location identified in operation 306. Thus, some embodiments of the concepts and technologies described herein can result in reduced consumption of network resources as the content can be stored at the resources at off-peak times and/or at other times at which network demand may be relatively low. As will be explained below, the preloading and/or locating of the virtual private locker 130 at the anticipated location can be scheduled to accommodate network demand. It should be understood that this example is illustrative and therefore should not be construed as being limiting in any way.

From operation 312, the method 300A proceeds to operation 314. At operation 314, the server computer 112 can determine if the hardware resources identified in operation 312 are available. The server computer 112 can access the network data 132 and determine if the hardware resources are currently being used or if the hardware resources can be dedicated to accommodate the anticipated demand. In some embodiments of the concepts and technologies described herein, the determination of operation 314 can be replaced with a determination as to whether or not the creation of the resources should be immediately undertaken or if the creation of the resources should instead be delayed until a later time.

If the server computer 112 determines in operation 314 that the hardware resources identified in operation 312 are not available or should not be immediately dedicated to the anticipated demand, the method 300A can proceed to operation 316. At operation 316, the server computer 112 can schedule resource creation to meet the anticipated demand. It can be appreciated that the server computer 112 can create resources for various users at various times. As such, the server computer 112 may determine that the hardware resources identified in operation 314 will be used to accommodate a first user, UserA, and afterwards will be dedicated to accommodating demand associated with a second user, UserB. It should be understood that this example is illustrative and therefore should not be construed as being limiting in any way.

As explained above, the server computer 112 can obtain network data 132 and use the network data 132 to determine the schedule according to which the hardware resources will be available and/or when the virtual resources (such as the virtual private locker 130) should be created. According to various embodiments, the creation of the resources is scheduled for a time at which network load is expected to be low, if possible, thereby resulting in reduced network demand at peak times. It should be understood that this example is illustrative and therefore should not be construed as being limiting in any way.

If the server computer 112 determines, in operation 314, that the hardware resources identified in operation 312 are available, the method 300A can proceed to operation 318. Similarly, the method 300A can proceed to operation 318 from operation 316. At operation 318, the server computer 112 can create one or more virtual resources to support the anticipated demand at the anticipated location. According to various embodiments, the server computer 112 can issue the commands 128 illustrated and described above with reference to FIG. 1. As such, it should be understood that the server computer 112 may or may not actually create the resources. Rather, the server computer 112 may issue commands 128 to other devices or entities to cause those devices or entities to instantiate the resources created in operation 314.

According to various embodiments, as noted above, the resources created in operation 318 can include virtual machine resources such as the virtual private locker 130 and/or the virtual machine resources 116A, 116B illustrated and described in detail above with reference to FIG. 1. As such, it can be appreciated that the resources created in operation 318 can include virtual computing resources and/or virtual data storage resources that can be hosted, executed, and/or otherwise provided by the hardware resources identified in operation 312. In some embodiments, as explained above, the resources can include a virtual private locker 130 that can store content for a particular user at the location determined in operation 306. By storing the content at the location, some embodiments of the concepts and technologies described herein can help reduce load on the network at particular times. Furthermore, network load and latency can be decreased using the virtual private locker 130 since the computing device 102 may only communicate with the virtual machine resources at the second location 114B instead of having to traverse the network 104 and/or portions thereof. It should be understood that this example is illustrative and therefore should not be construed as being limiting in any way.

From operation 318, the method 300A proceeds to operation 320. At operation 320, the server computer 112 can determine if the content associated with the anticipated demand is pre-loadable to the resources created in operation 318. Thus, for example, the server computer 112 can determine if the content corresponds to pre-loadable data such as a website, a video file, an audio file, text, or the like. Alternatively, the server computer 112 can determine if the content corresponds to non-pre-loadable content such as streaming data, streaming audio or video, phone calls, or the like.

If the server computer 112 determines, in operation 320, that the content corresponds to pre-loadable data, the method 300A can proceed to operation 322. In operation 322, the server computer 112 can load the content identified in operation 310 to the resources created at operation 318. According to various embodiments, the server computer 112 can issue the commands 128 illustrated and described above with reference to FIG. 1 to the hardware resources and/or virtual machine resources identified and/or created in operations 312-318, respectively, to load the content identified in operation 310 to the resources.

According to various embodiments, the resources include a virtual private locker 130, and as such, operation 320 includes loading the pre-loadable data to the virtual private locker 130. As such, it should be understood that the server computer 112 may initiated loading of the content to the resources. Thus, the server computer 112 may issue commands 128 to other devices or entities to cause those devices or entities to load the content to the resources created in operation 318. It should be understood that this example is illustrative and therefore should not be construed as being limiting in any way.

It should be appreciated that if the content is not preloaded to the resources in operation 322, that the resources can instead be instantiated at the scheduled time and then can provide the requested content. Thus, even if the content to be provided is not pre-loadable, the concepts and technologies described herein can reduce network load and/or latency by preconfiguring network resources to accommodate specific demand. It should be understood that this example is illustrative and therefore should not be construed as being limiting in any way.

From operation 322, the method 300A proceeds to operation 324. The method 300A also can proceed to operation 324 from operation 320 if the server computer 112 determines that the content is not pre-loadable data. The method 300A can end at operation 324.

According to some embodiments of the concepts and technologies described herein, the resource management service 110 can be configured to manage the virtual private locker 130 or other resources after creation of the virtual private locker 130 and/or dedication or allocation of the resources as illustrated and described herein with reference to the method 300A.

In particular, the resource management service 110 can be configured, in various embodiments, to monitor usage of the virtual private locker 130 and/or other resources dedicated to a particular user, device, or account, and to execute operations to free resources when no longer needed. For example, if a particular virtual private locker 130 is created for a particular user and a particular instance of content is loaded to the virtual private locker 130, the content can be deleted after being downloaded, streamed, or indicated as being unwanted by a device, account, or other entity associated with the particular user.

Similarly, if the user or device associated with a particular virtual private locker 130 leaves an area associated with the virtual private locker 130, the resource management service 110 can delete the content and/or reallocate the resources used to provide the virtual private locker 130. Thus, some embodiments of the concepts and technologies described herein can be used to not only reduce resource usage during loading content to the virtual private locker 130 as illustrated and described herein, but also to manage resource usage after creation of the virtual private locker 130 and/or allocation or dedication of other resources as illustrated and described herein. It should be understood that this example is illustrative and therefore should not be construed as being limiting in any way.

According to one contemplated embodiment, a method for managing the resources can be executed by the server computer 112. One contemplated example of a method 300B for managing the resources is illustrated and described with reference to FIG. 3B. The method 300B begins, and flow proceeds to operation 330. In operation 330, the server computer 112 can monitor resources dedicated to a particular user, device, or other entity. In some embodiments, the server computer 112 can monitor the resources created in operation 316 of the method 300A illustrated and described above with reference to FIG. 3A. It should be understood that this example is illustrative and therefore should not be construed as being limiting in any way.

From operation 330, the method 300B proceeds to operation 332. In operation 332, the server computer 112 can determine if the resources being monitored should be maintained. The server computer 112 can alternatively determine if the resources being monitored should not be maintained. In either embodiment, the server computer 112 can determine if the content loaded to the resources and/or the resources themselves are needed or not needed based upon determining if the user, device, or other entity will likely access the content and/or otherwise use the resources again. If the content corresponds to a one-time use or consumption such as a download of email, accessing a website or service, or the like, the server computer 112 can determine that the resources are likely not to be used again if the user, device, or other entity has already accessed those resources.

Similarly, if the server computer 112 determines that the user, device, or other entity has left an area or geographic location associated with the resources (e.g., a virtual private locker 130), the server computer 112 can determine that the resources likely will not be used again. Because the server computer 112 can determine that resources will or will not be needed based upon various considerations, it should be understood that these examples are illustrative and therefore should not be construed as being limiting in any way.

If the server computer 112 determines, in operation 332, that the resources being monitored will be needed, the method 300B can return to operation 330. The server computer 112 can repeat the operations 330 and 332 until the server computer 112 determines, in any iteration of operation 332, that the resources being monitored are not needed any longer. If the server computer 112 determines that the resources being monitored are no longer needed, the method 300B can proceed to operation 334.

At operation 334, the server computer 112 can reallocate, delete, terminate, “tear down,” or otherwise free the resources being monitored. Thus, the server computer 112 can delete content saved to resources, terminate or delete applications executed by the resources, free storage capacity provided by the resources, free processing capacity provided by the resources, and/or otherwise de-allocate, reallocate, or otherwise free the resources for other purposes.

From operation 334, the method 330B can proceed to operation 336. The method 300B can end at operation 336. It should be understood that the method 300B can be executed between operations 322 and 324 of the method 300A illustrated and described above, or executed at other times and/or under other conditions as illustrated and described herein.

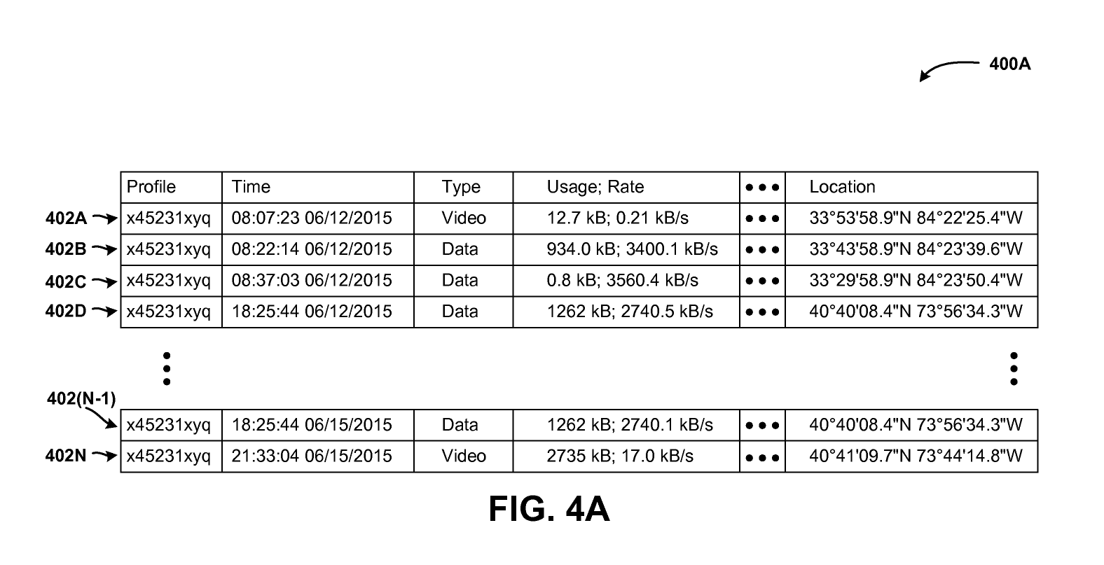

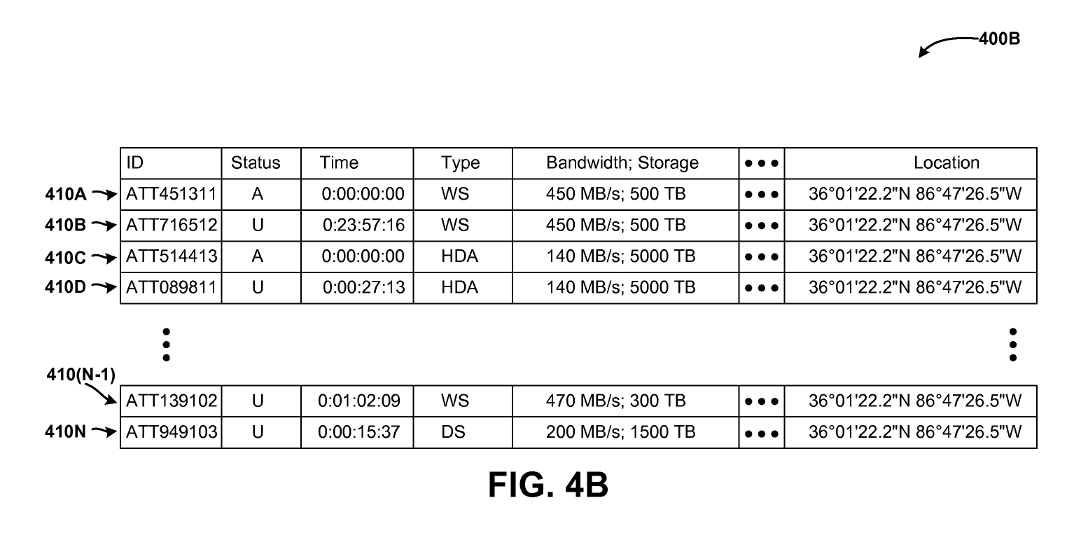

Turning now to FIGS. 4A-4B, additional aspects of the concepts and technologies described herein for providing a resource management service will be described in detail. In particular, FIG. 4A illustrates a data structure 400A that can be used to represent the reports 122A, 122B and/or the models 124 illustrated and described herein, and FIG. 4B illustrates a data structure 400B that can be used to represent the network data 132 illustrated and described herein. The data structures 400A, 400B are illustrated in FIGS. 4A-4B as tables for clarity, but it should be understood that these examples are illustrative. For this and other reasons, it should be understood that the example data structures 400A, 400B are illustrative and should not be construed as being limiting in any way.

As shown in FIG. 4A, the data structure 400A can include a number of data usage instances 402A-N (hereinafter collectively and/or generically referred to as “data usage instances 402”). Each of the data usage instances 402, represented in FIG. 4A as rows, can represent one data usage or interaction. For example, the data usage instance 402A can represent a particular user (shown under the “profile” column) consuming, using, or interacting with a particular type (shown under the “type” column) of data at a particular time (shown under the “time” column). The data usage instance 402A also can indicate an amount of data used during the interaction and a rate at which the data was consumed or used (shown under the “usage; rate” column). The data usage instance 402A also can indicate a location at which the data usage or consumption occurred (shown under the “location” column), for example a location at which a device associated with the usage was located at the time shown in the data usage instance 402A. Although not shown in FIG. 4A, the data structure 400A also can include a column that indicates if the corresponding data or content is pre-loadable. Because additional and/or alternative data can be represented in the data structure 400A, it should be understood that this example is illustrative and therefore should not be construed as being limiting in any way.

As illustrated and described above with reference to FIG. 1, the data structure 400A can be used to track times at which content is used or interacted with by a particular user, account, or device; types of content used or interacted with by a particular user, account, or device; amounts and/or rates of data used or interacted with by a particular user, account, or device; and locations at which the user, account, or device interacted with the content. It should be understood that this example is illustrative and therefore should not be construed as being limiting in any way.

As shown in FIG. 4B, the data structure 400B can include a number of resource records 410A-N (hereinafter collectively and/or generically referred to as “resource records 410”). Each of the resource records 410, represented in FIG. 4B as rows, can represent a hardware resource that can be used to support content use or interactions. For example, the resource record 410A represents a particular web server, its current operating status (available), a time at which the web server is going to be available (in this case 0 because it already is available), bandwidth and data storage availability associated with the web server, and a location at which the web server is located.

By way of another example, the resource record 410D represents a particular disk array, its current operating status (unavailable), a time at which the web server is going to be available (in this case twenty seven minutes and thirteen seconds), bandwidth and data storage availability associated with the disk array, and a location at which the disk array is located. Because additional and/or alternative data can be represented in the data structure 400B, it should be understood that the illustrated and described example is illustrative and therefore should not be construed as being limiting in any way.

It can be appreciated with reference to FIG. 4A that the server computer 112 can access the models 124 and/or the reports 122A, 122B to determine how, when, and where a user is anticipated to want to use or access content. It can be appreciated with reference to FIG. 4B that the server computer 112 can access the network data 132 to determine how, when, and where a network resource is anticipated to be available. With knowledge of both, as illustrated and described above with reference to FIG. 3A, the server computer 112 can create resources to support anticipated demand. It should be understood that these examples are illustrative and therefore should not be construed as being limiting in any way.

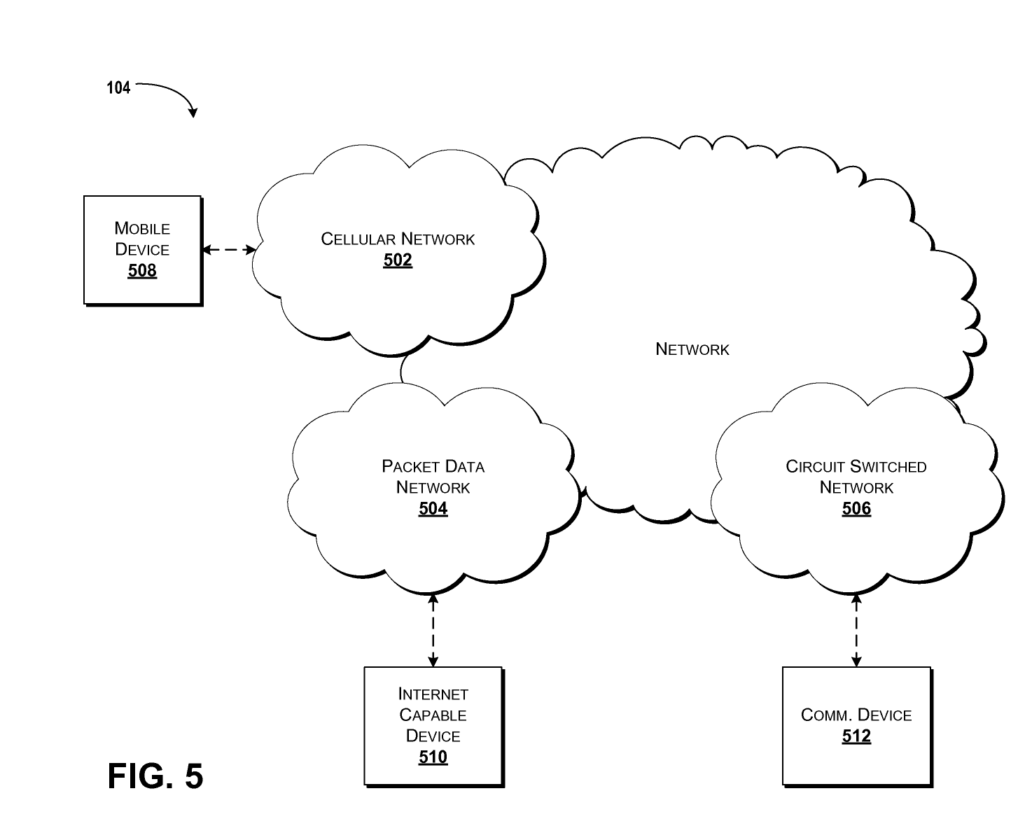

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards as well as evolved and future mobile standards.

The packet data network 504 includes various devices, for example, servers, computers, databases, and other devices in communication with another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

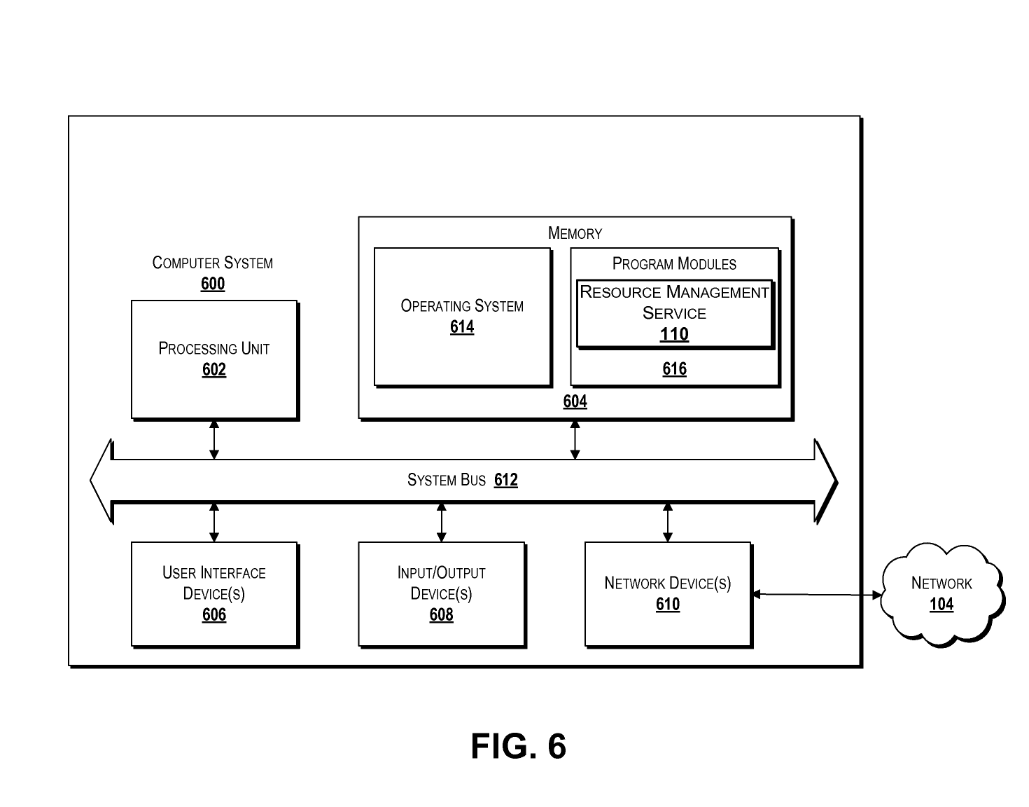

FIG. 6 is a block diagram illustrating a computer system 600 configured to provide the functionality described herein for a resource management service, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the resource management service 110. This and/or other programs can be embodied in computer-readable media containing instructions that, when executed by the processing unit 602, perform one or more of the methods 200, 300A, 300B described in detail above with respect to FIGS. 2-3. According to embodiments, the program modules 616 may be embodied in hardware, software, firmware, or any combination thereof. Although not shown in FIG. 6, it should be understood that the memory 604 also can be configured to store the reports 122A, 122B, the virtual machine resources 116A, 116B, the models 124, the virtual private locker 130, the network data 132 and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

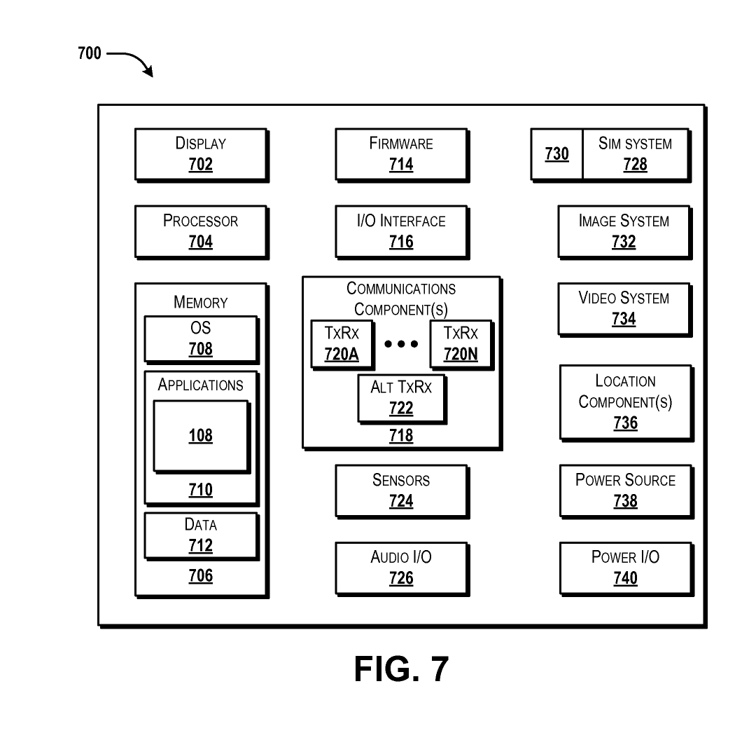

Turning now to FIG. 7, an illustrative mobile device 700 and components thereof will be described. In some embodiments, the computing device 102 described above with reference to FIG. 1 can be configured as and/or can have an architecture similar or identical to the mobile device 700 described herein in FIG. 7. It should be understood, however, that the computing device 102 may or may not include the functionality described herein with reference to FIG. 7. While connections are not shown between the various components illustrated in FIG. 7, it should be understood that some, none, or all of the components illustrated in FIG. 7 can be configured to interact with one other to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements for <<UI INFORMATION from APPLICATION>>, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710 such as the application programs 108, the model generation application described above, other computer-executable instructions stored in a memory 708, or the like. In some embodiments, the applications 706 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, viewing content, requesting content, viewing contents of a virtual private locker 130, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the content 120, the content 120′, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interfaced 716 can be configured to support the input/output of data such as location information, time information, reports such as the reports 122A, 122B, the models 124, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ411) port, an RJ11 port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

Based on the foregoing, it should be appreciated that systems and methods for providing a resource management service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A method comprising:
receiving, at a processor executing a resource management service, a content usage report comprising geographic location data and content usage data;
generating, by the processor and based upon the content usage report, a model that indicates content used by a computing device and geographic locations at which the content is used;
determining, by the processor and based upon the model, anticipated content that is expected to be received by the computing device and an anticipated location at which the anticipated content is expected to be received;
identifying, by the processor, a resource available to support storage of the anticipated content;
generating a command, by the processor, to allocate the resource to support storage of the anticipated content; and
instructing, by the processor, the resource to download the anticipated content and to store the anticipated content.

2. The method of claim 1, wherein the anticipated content is downloaded to a virtual private locker associated with the computing device.

3. The method of claim 2, wherein the virtual private locker is located within a predetermined proximity of the anticipated location.

4. The method of claim 2, wherein the virtual private locker comprises a virtual data storage device, and wherein the resource comprises a virtual computer.

5. The method of claim 1, wherein identifying the resource comprises:
obtaining network data that indicates availability of network resources comprising the resource;
determining that the resource is available and that the resource is located within a proximity of the anticipated location; and
selecting the resource.

6. The method of claim 1, wherein identifying the resource comprises:
obtaining network data that indicates availability of network resources comprising the resource;
determining that the resource is unavailable and that the resource is located within a proximity of the anticipated location;
scheduling a time at which the resource is to be selected; and
selecting the resource at the time scheduled.

7. The method of claim 1, wherein the report comprises:
profile data identifying an entity associated with the content usage; and
time data identifying a time at which the content was used.

8. The method of claim 1, wherein the model comprises profile data, time data, the content usage data, the location data, and history data identifying a trend associated with data included in the model.

9. The method of claim 1, wherein the content usage data comprises a uniform resource identifier via which the content is accessed.

10. The method of claim 1, wherein instructing the resource to download the anticipated content comprises:
determining that the anticipated content is pre-loadable;
instructing the resource to create a virtual private locker; and
instructing the resource to download the anticipated content and to store the anticipated content in the virtual private locker.

11. A system comprising:
a processor; and
a memory that stores computer-executable instructions that, when executed by the processor, cause the processor to perform operations comprising
receiving a content usage report comprising geographic location data and content usage data,
generating, based upon the content usage report, a model that indicates content used by a computing device and geographic locations at which the content is used,
determining, based upon the model, anticipated content that is expected to be received by the computing device and an anticipated location at which the anticipated content is expected to be received,
identifying a resource available to support storage of the anticipated content,
generating a command to allocate the resource to support storage of the anticipated content, and
instructing the resource to download the anticipated content and to store the anticipated content.

12. The system of claim 11, wherein the anticipated content is downloaded to a virtual private locker, and wherein the virtual private locker is associated with the computing device.

13. The system of claim 12, wherein the virtual private locker is located within a predetermined proximity of the anticipated location.

14. The system of claim 11, wherein identifying the resource comprises:
obtaining network data that indicates availability of network resources comprising the resource;
determining that the resource is available and that the resource is located within a proximity of the anticipated location; and
selecting the resource.

15. The system of claim 11, wherein instructing the resource to download the anticipated content comprises:
determining that the anticipated content is pre-loadable;
instructing the resource to create a virtual private locker; and
instructing the resource to download the anticipated content and to store the anticipated content in the virtual private locker.

16. A computer storage medium having computer-executable instructions stored thereon that, when executed by a processor, cause the processor to perform operations comprising:
receiving a content usage report comprising geographic location data and content usage data;
generating, based upon the content usage report, a model that indicates content used by a computing device and geographic locations at which the content is used;
determining, based upon the model, anticipated content that is expected to be received by the computing device and an anticipated location at which the anticipated content is expected to be received;
identifying a resource available to support storage of the anticipated content;
generating a command to allocate the resource to support storage of the anticipated content; and
instructing the resource to download the anticipated content and to store the anticipated content.

17. The computer storage medium of claim 16, wherein the anticipated content is downloaded to a virtual private locker, and wherein the virtual private locker is associated with the computing device.

18. The computer storage medium of claim 17, wherein the virtual private locker is located within a predetermined proximity of the anticipated location.

19. The computer storage medium of claim 16, wherein identifying the resource comprises:
obtaining network data that indicates availability of network resources comprising the resource;
determining that the resource is available and that the resource is located within a proximity of the anticipated location; and
selecting the resource.

20. The computer storage medium of claim 16, wherein instructing the resource to download the anticipated content comprises:
determining that the anticipated content is pre-loadable;
instructing the resource to create a virtual private locker; and
instructing the resource to download the anticipated content and to store the anticipated content in the virtual private locker.
